(19) United States
(12) Patent Application Publication
(10) Pub. No.: US 2021/0317925 A1
(43) Pub. Date: Oct. 14, 2021

(54) MANIFOLD FOR CONNECTING TWO OR MORE FLUID CONTROL DEVICES

(71) Applicant: TESCOM CORPORATION, Elk River, MN (US)

(72) Inventor: William J. Neubauer, Ramsey, MN (US)

(21) Appl. No.: 16/861,878

(22) Filed: Apr. 29, 2020

Related U.S. Application Data
(60) Provisional application No. 63/009,417, filed on Apr. 13, 2020.

(51) Int. Cl. F16K 27/00

(52) U.S. Cl. CPC F16K 27/003

(57) ABSTRACT

A manifold for connecting two or more fluid control devices to a common fluid source. The manifold includes a first manifold block adapted to be coupled to a first fluid control device, and a second manifold block adapted to be coupled to a second fluid control device. The manifold also includes a first slot formed in the first manifold block and a second slot formed in the second manifold block. The first slot and second slot each have a substantially circular shape in cross-section. The manifold further includes a slot connector configured to couple the first manifold block and the second manifold block together, the slot connector having a first end sized to be disposed in the first slot and a second end sized to be disposed in the second slot.

### FIELD OF THE DISCLOSURE

The present disclosure relates generally to manifolds and, in particular, to a manifold for connecting two or more fluid control devices.

### BACKGROUND OF THE DISCLOSURE

Process control systems often employ fluid control devices (e.g., control valves) to control the flow of process fluids. A process control system may, for example, include a plurality of fluid control devices to control fluid flow through a plurality of fluid flow passageways in those plurality of fluid control devices. In some instances, the process control system may include a manifold that fluidly couples the plurality of fluid control devices together in a compact, organized manner. For example, the manifold may fluidly couple the plurality of fluid control devices together in a compact, organized manner that simultaneously fluidly couples a common fluid source to the plurality of fluid flow passageways of the plurality of fluid control devices.

### BRIEF DESCRIPTION OF THE DRAWINGS

FIG. 1A is a top view of a known manifold including three manifold blocks.

FIG. 1B is a side view of one of the manifold blocks of FIG. 1A.

FIG. 2A is a side view of another known manifold including two manifold blocks coupled together via a manifold plate and keys disposed in keyways formed in each of the two manifold blocks.

FIG. 2B is a partial cutaway view of a back side of the two manifold blocks of FIG. 2A, showing the keys disposed in keyways.

FIG. 2C is a perspective view of portions of the two manifold blocks of FIG. 2A and the keys and keyways of FIG. 2B.

FIG. 2D is a perspective view of the cutting tool used to form the keyways in the two manifold blocks of FIG. 2A.

FIG. 3A is a perspective view of one example of a manifold constructed in accordance with the principles of the present disclosure, the manifold including two manifold blocks coupled together via (i) slot connectors disposed in slots formed in each of the two manifold blocks, and (ii) fasteners arranged to retain the slot connectors in the slots.

FIG. 3B is an exploded view of the manifold of FIG. 3A.

FIG. 3C is a close-up view of a portion of the manifold of FIG. 3A, showing two of the slots formed in one of the manifold blocks.

FIG. 3D is a perspective view of one of the slot connectors employed in the manifold of FIG. 3A.

FIG. 3E is a plan view of one example of a standard machining tool used to form the slots in the manifold of FIG. 3A.

### DETAILED DESCRIPTION

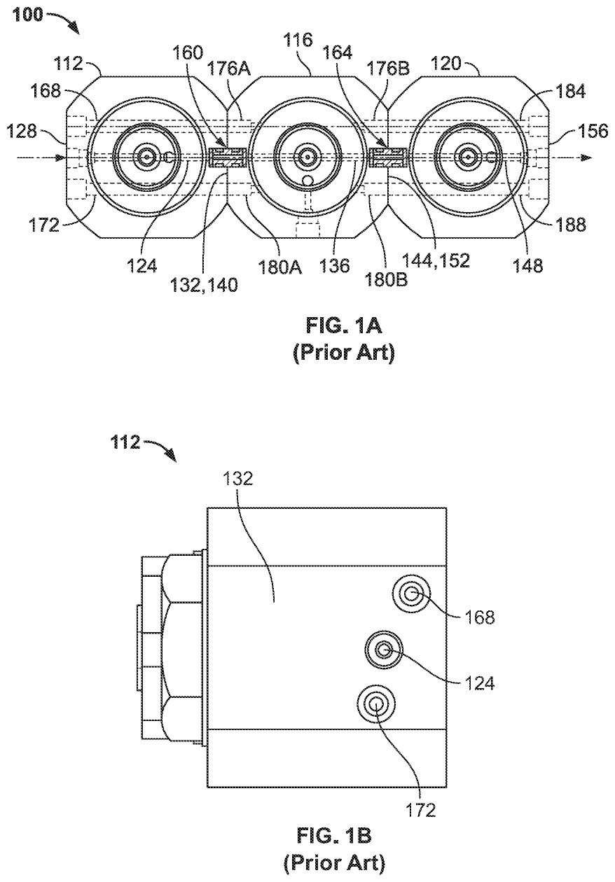

FIGS. 1A and 1B illustrate an example of a known manifold 100 that may be used to fluidly couple a plurality of fluid control devices together in a compact, organized manner and to fluidly couple the plurality of fluid control devices to a common fluid source (not shown). The known manifold 100 includes a first manifold block 112, a second manifold block 116, and a third manifold block 120, each block being coupled to a fluid control device, such that in this example the manifold 100 fluidly couples three fluid control devices together.

The first manifold block 112 has a first fluid flow passageway 124 that extends therethrough from a first side 128 of the first manifold block 112 to a second side 132 of the first manifold block 112. The second manifold block 116 similarly has a second fluid flow passageway 136 that extends therethrough from a first side 140 of the second manifold block 116 to a second side 144 of the second manifold block 116. As illustrated in FIG. 1A, the second fluid flow passageway 136 is aligned with the first fluid flow passageway 124. The third manifold block 120 likewise has a third fluid flow passageway 148 that extends therethrough from a first side 152 of the third manifold block 120 to a second side 156 of the third manifold block 120. As illustrated in FIG. 1A, the third fluid flow passageway 148 is aligned with the second fluid flow passageway 136, such that the third fluid flow passageway 148 is also aligned with the first fluid flow passageway 124.

The known manifold 100 also includes first and second fluid connectors 160, 164 that fluidly couple the first manifold block 112, the second manifold block 116, and the third manifold block 120 together. As illustrated in FIG. 1A, the first fluid connector 160 is partially disposed and partially extends through each of the first fluid flow passageway 124 and the second fluid flow passageway 136. As the first fluid connector 160 defines an opening therethrough, the first fluid connector 160 therefore serves to fluidly couple the first fluid flow passageway 124 of the first manifold block 112 to the second fluid flow passageway 136 of the second manifold block 116, thereby allowing fluid to flow therethrough between the first manifold block 112 and the second manifold block 116. Meanwhile, the second fluid connector 164 is partially disposed and partially extends through each of the second fluid flow passageway 136 and the third fluid flow passageway 148. As the second fluid connector 164 also defines an opening therethrough, the second fluid connector 164 therefore serves to fluidly couple the second fluid flow passageway 136 of the second manifold block 116 to the third fluid flow passageway 148 of the third manifold block 120, thereby allowing fluid to flow therethrough between the second manifold block 116 and the third manifold block 120.

The first manifold block 112, the second manifold block 116, and the third manifold block 120 are also secured together, but in a manner that maintains the integrity of the first fluid flow passageway 124, the second fluid flow passageway 136, and the third fluid flow passageway 148. More particularly, the first, second, and third manifold blocks 112, 116, 120 are secured together using bolts disposed in a network of internal holes that are staggered and sized and shaped so as to avoid intersecting with the first, second, and third fluid flow passageways 124, 136, 148, which would in turn comprise or otherwise negatively affect the flow characteristics of the manifold 100. To this end, the first manifold block 112 has first and second through holes 168, 172 that each extend therethrough from the first side 128 to the second side 132 in a staggered manner, and the third manifold block 120 has first and second through holes 184, 188 that each extend therethrough from the first side 152 to the second side 156 in a staggered manner. However, unlike the first manifold block 112 and the third manifold block 120, the second manifold block 116 has a pair of first holes 176A, 1768 and a pair of second holes 180A, 1808 that, while also staggered, extend only partially therethrough. As illustrated in FIG. 1A, the first hole 176A is aligned with the first through hole 168 but only extends from the first side 140 to an interior portion of the second manifold block 116. Meanwhile, the first hole 1768 is aligned with both the first hole 176A and the first through hole 184, but only extends from an interior portion of the second manifold block 116 to the second side 144. Moreover, the first holes 176A, 1768 have different cross-sectional shapes and sizes than the first through holes 168, 184. As also illustrated in FIG. 1A, the second hole 180A is aligned with the second through hole 172 but only extends from the first side 140 to an interior portion of the second manifold block 116. Meanwhile, the second hole 1808 is aligned with both the second hole 180A and the second through hole 188, but only extends from an interior portion of the second manifold block 116 to the second side 144. Moreover, the second holes 180A, 1808 have different cross-sectional shapes and sizes than the second through holes 172, 188. First and second bolts (not shown) are in turn disposed in this network of internal holes to secure the first, second, and third manifold blocks 112, 116, and 120 together. In particular, the first bolt extends through the first through hole 168, the first holes 176A, 176B, and the first through hole 184, while the second bolt extends through the second through hole 172, the second holes 180A, 180B, and the second through hole 188.

Although this arrangement serves to secure the first, second, and third manifold blocks 112, 116, 120 together, staggering, sizing, and shaping the network of internal holes in this manner creates a multitude of manufacturing and assembly problems. First, because, for example, the second manifold block 116 is different from the first manifold block 112, the first, second, and third manifold blocks 112, 116, 120 are not interchangeable with one another. Thus, multiple different types of replacement manifold blocks must be kept in inventory and/or replacement parts must be tailored on-site to replace one or more of the first, second, and third manifold blocks 112, 116, 120. Second, forming and/or aligning the staggered holes in the required manner may increase manufacturing and installation time and costs. Third, if it is necessary to include an additional manifold block (coupled to another fluid control device) between two of the first, second, and third manifold blocks 112, 116, 120, the additional manifold block and/or the existing manifold blocks will have to be modified so as to permit this inclusion, thereby again increasing manufacturing and installation costs and time.

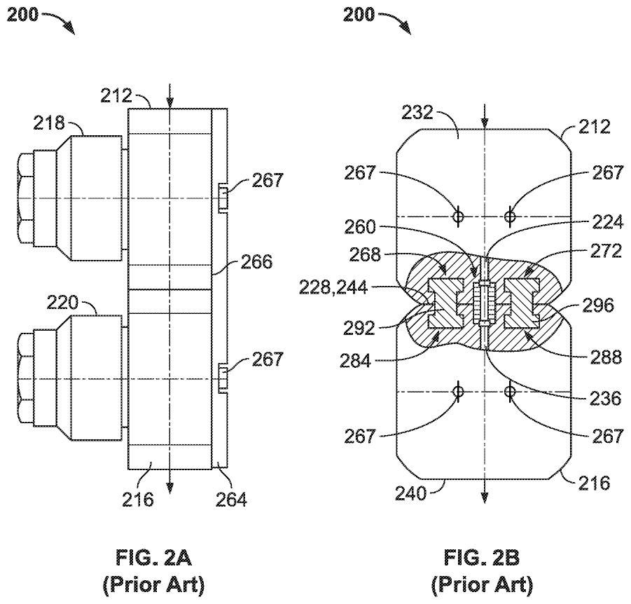

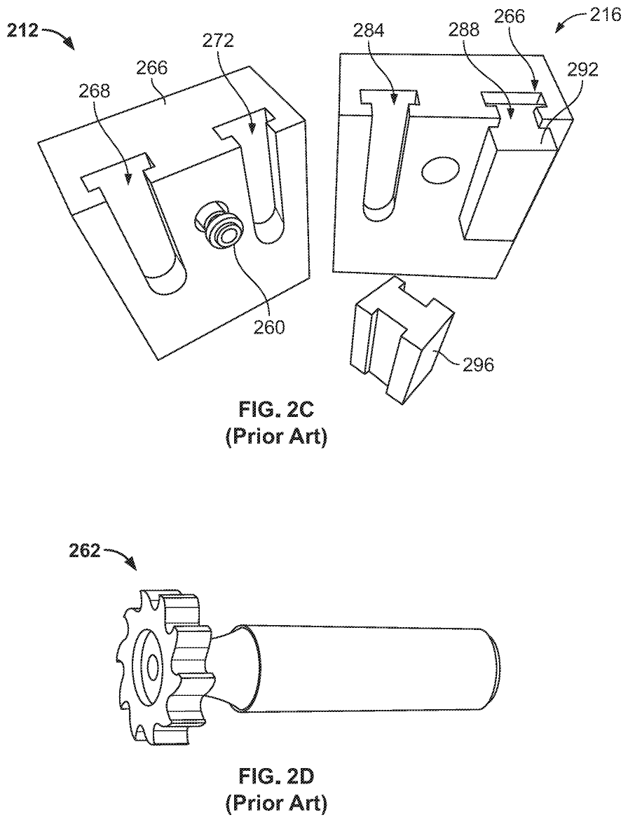

FIGS. 2A-2C illustrate another example of a known manifold 200 that may be used to fluidly couple a plurality of fluid control devices together in a compact, organized manner and to fluidly couple the plurality of fluid control devices to a common fluid source (not shown). The known manifold 200 includes a first manifold block 212 and a second manifold block 216, each block being coupled to a fluid control device (218 or 220), such that in this example the manifold 200 fluidly couples two fluid control devices 218, 220 together.

The first manifold block 212 has a first fluid flow passageway 224 that extends therethrough from a first side 228 of the first manifold block 212 to a second side 232 of the first manifold block 212. The second manifold block 216 similarly has a second fluid flow passageway 236 that extends therethrough from a first side 240 of the second manifold block 216 to a second side 244 of the second manifold block 216. As best illustrated in FIG. 2B, the second fluid flow passageway 236 is aligned with the first fluid flow passageway 224.

The known manifold 200 also includes a fluid connector 260 that fluidly couples the first manifold block 212 and the second manifold block 216 together. As illustrated in FIG. 2B, the fluid connector 260 is partially disposed and partially extends through each of the first fluid flow passageway 224 and the second fluid flow passageway 236. Like the fluid connectors 160, 164, the fluid connector 260 defines an opening therethrough. The fluid connector 260 therefore serves to fluidly couple the first fluid flow passageway 224 of the first manifold block 212 to the second fluid flow passageway 236 of the second manifold block 216, thereby allowing fluid to flow therethrough between the first manifold block 212 and the second manifold block 216.

The first manifold block 212 and the second manifold block 216 are also secured together, but in a manner that differs from how the first, second, and third manifold blocks 112, 116, 120 are secured together. Instead, the first manifold block 212 and the second manifold block 216 are secured together using (i) keys disposed in keyways specially formed in the first manifold block 212 and the second manifold block 216 using the cutting tool 262 shown in FIG. 2D, and (ii) a manifold plate 264 coupled to a back side 266 of the first and second manifold blocks 212, 216 via fasteners 267 disposed in apertures formed in the back side 266. As best illustrated in FIGS. 2B and 2C, the first manifold block 212 has first and second keyways 268, 272 formed therein using the cutting tool 262. Each of the first and second keyways 268, 272 has a T-shape in cross-section. Likewise, as also best illustrated in FIGS. 2B and 2C, the second manifold block 216 has first and second keyways 284, 288 formed therein using the cutting tool 262, with the first and second keyways 284, 288 being aligned with the first and second keyways 268, 272, respectively. Each of the first and second keyways 284, 288 also has a T-shape in cross-section that is identical to the T-shape in cross-section of the first and second keyways 268, 272, respectively. A first key 292 and a second key 296 are in turn disposed in the keyways 268, 272 and 284, 288, respectively, to secure the first and second manifold blocks 212, 216 together. As best illustrated in FIGS. 2B and 2C, each of the first and second keys 292, 296 has an I-shape (in cross-section), such that a first end of the first key 292 is disposed in the first keyway 268, a second end of the first key 292 is disposed in the first keyway 284, a first end of the second key 296 is disposed in the second keyway 272, and a second end of the second key 296 is disposed in the second keyway 288.

Although this arrangement serves to secure the first and second manifold blocks 212, 216 together, securing the first and second manifold blocks 212, 216 in this manner creates its own set of manufacturing problems. First, forming the first and second keyways 268, 272, 284, 288 in the first and second manifold blocks 212, 216 using the cutting tool 262 is a tedious, time-consuming, and complex manufacturing process. Indeed, this process tends to significantly increase the risk that the manifold 200 needs to be scrapped, which is of course costly and slows down manufacturing. Second, the manifold plate 264 is a large and customized part that is expensive and time-consuming to produce and replace.

The present disclosure is directed to a manifold that may be used to fluidly couple a plurality of fluid control devices together in a compact, organized manner and to fluidly couple the plurality of fluid control devices to a common fluid source (not shown), but also aims to solve (or at least minimize) the problems associated with manufacturing and installing the known manifold 100 and the known manifold 200. More particularly, the manifold disclosed herein includes manifold blocks that are easier and cheaper to manufacture and install than the manifold blocks of the known manifold 100 and the known manifold 200. For example, the manifold blocks of the manifold disclosed herein do not have staggered and differently sized and shaped internal holes, such that the manifold blocks are interchangeable with one another. As another example, the manifold blocks of the manifold disclosed herein have slots that are easier and cheaper to manufacture than the keyways 268, 272, 284, 288, and the manifold blocks are secured together without using a manifold plate (e.g., the manifold plate 264), thereby reducing manufacturing costs and waste.

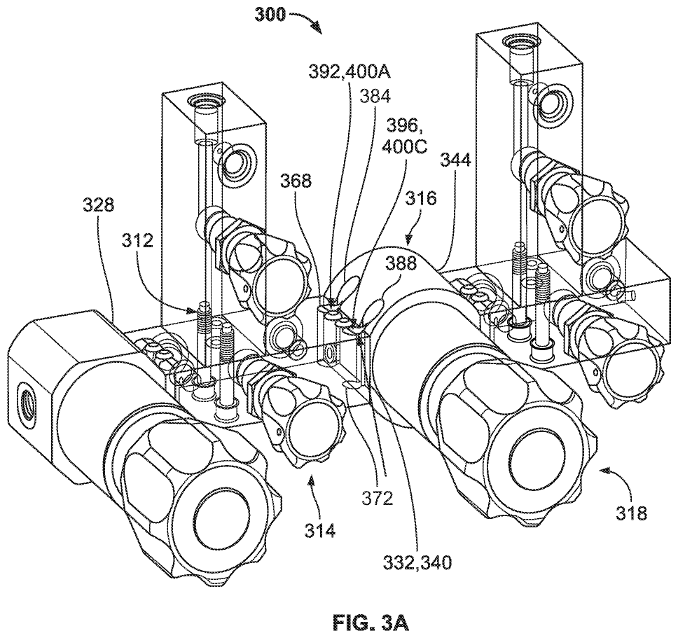

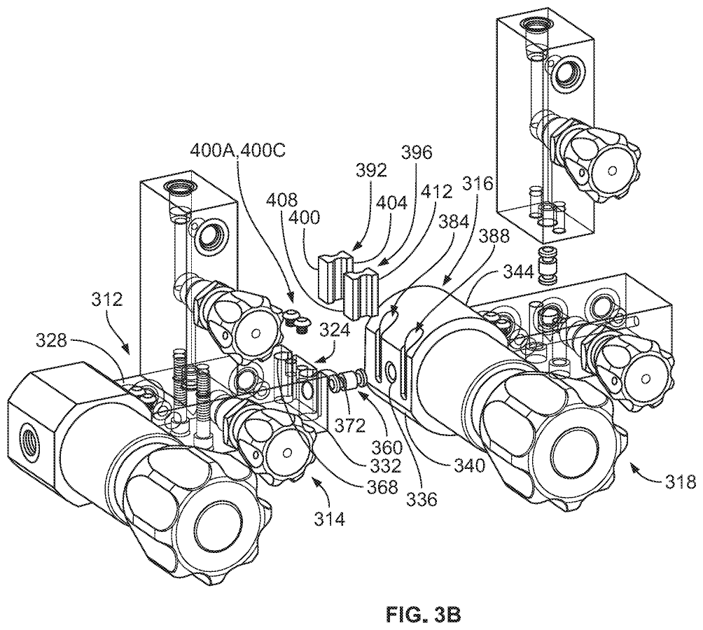

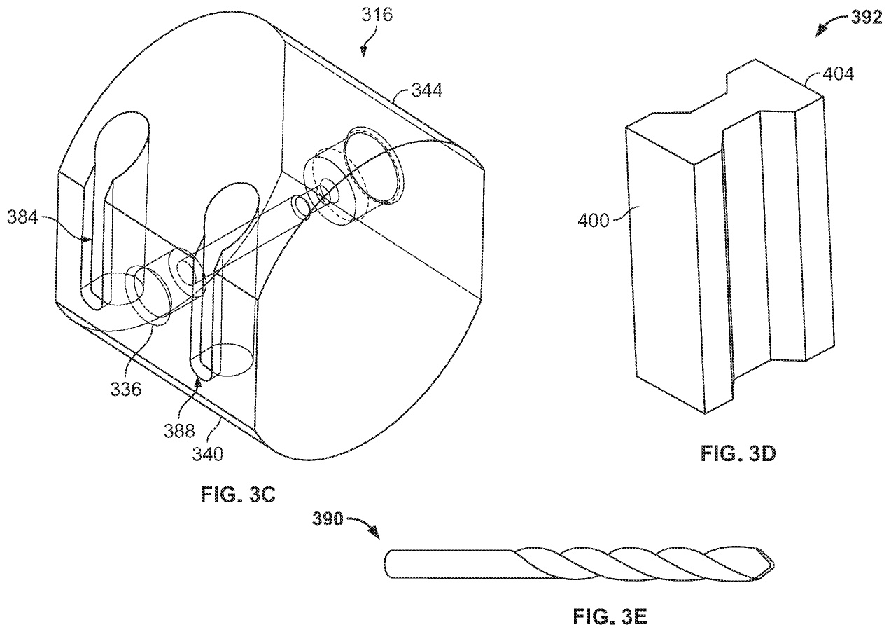

FIGS. 3A-3E illustrate one example of a manifold 300 constructed in accordance with the principles of the present disclosure. In this example, the manifold 300 includes a first manifold block 312 coupled to a first fluid control device 314 and a second manifold block 316 coupled to a second fluid control device 318, such that in this example the manifold 300 fluidly couples the first fluid control device 314 and the second fluid control device 318 together and to, for example, a common fluid source. In other examples, the manifold 300 can include additional manifold blocks, such that the manifold 300 can fluidly couple more than two fluid control devices together and to, for example, the common fluid source.

Like the first manifold block 112 and the first manifold block 212, the first manifold block 312 in this example has a first fluid flow passageway 324 that extends therethrough from a first side 328 of the first manifold block 312 to a second side 332 of the first manifold block 312. The second manifold block 316 in this example similarly has a second fluid flow passageway 336 that extends therethrough from a first side 340 of the second manifold block 316 to a second side 344 of the second manifold block 316. As best illustrated in FIG. 3B, the second fluid flow passageway 336 is aligned with the first fluid flow passageway 324. In other examples, however, the first manifold block 312 and/or the second manifold block 316 can include more than one fluid flow passageway. For example, the first manifold block 312 can include two fluid flow passageways, three fluid flow passageways, or any other number of fluid flow passageways.

Moreover, like the manifold 100 and the manifold 200, the manifold 300 also includes a fluid connector 360 that fluidly couples the first manifold block 312 and the second manifold block 316 together. As best illustrated in FIG. 3A, the fluid connector 360 is partially disposed and partially extends through each of the first fluid flow passageway 324 and the second fluid flow passageway 336. Like the fluid connectors 160, 164 and the fluid connector 260, the fluid connector 360 defines an opening therethrough. The fluid connector 360 therefore serves to fluidly couple the first fluid flow passageway 324 of the first manifold block 312 to the second fluid flow passageway 336 of the second manifold block 316, thereby allowing fluid to flow therethrough between the first manifold block 312 and the second manifold block 316.

However, the first manifold block 312 and the second manifold block 316 are secured together in a manner that differs from how the first, second, and third manifold blocks 112, 116, 120 and how the first and second manifold blocks 212, 216 are secured together. Instead, the first manifold block 312 and the second manifold block 316 are secured together using (i) slot connectors disposed in slots formed in the first manifold block 312 and the second manifold block 316 using a standard machining tool (rather than the cutting tool 218), and (ii) fasteners disposed in the slots to retain the slot connectors therein.

As best illustrated in FIGS. 3A-3C, the manifold 300 in this example includes first and third slots 368, 372 formed in the first manifold block 312 and second and fourth slots 384, 388 formed in the second manifold block 316. The first, third, second, and fourth slots 368, 372, 384, 388 are preferably drilled therein using a drill bit, such as the drill bit 390 shown in FIG. 3E. In turn, as best illustrated in FIG. 3C, the first, third, second, and fourth slots 368, 372, 384, 388 each have a substantially circular shape in cross-section, with a first portion that has a circular shape in cross-section and is spaced from the respective first side of the first and second manifold blocks 312, 216, and a second portion that has a U-shape in cross-section and connects the respective first side of the first and second manifold blocks 312, 316 to the first portion. In other examples, the slots 368, 372, 384, 388 can be formed therein using a different standard machining tool. In these or other examples, the slots 368, 372, 384, 388 can have different sizes and/or cross-sectional shapes. As an example, the slots 368, 372, 384, 388 can have a circular, rectangular, triangular, irregular, or other shape in cross-section. Moreover, in other examples, the manifold 300 may only include two slots (e.g., the slots 368, 384) or may include more than four slots. Further, it will be appreciated that the first and third slots 368, 372 only extend partially through the first manifold block 312, and the second and fourth slots 384, 388 only extend partially through the second manifold block 316.

As best illustrated in FIGS. 3A, 3B, and 3D, the manifold 300 in this example includes first and second slot connectors 392, 396 configured to couple the first manifold block 312 and the second manifold block 316 together. To this end, the first and second slot connectors 392, 396 are generally sized to be disposed in the first and second slots 368, 384 and the third and fourth slots 372, 388, respectively. More particularly, the first slot connector 392 is sized to be disposed in the first and second slots 368, 384, such that the first slot connector 392 has a first end 400 sized to be disposed in the first slot 368 and a second end 404, opposite the first end 400, sized to be disposed in the second slot 384. Meanwhile, the second slot connector 396 is sized to be disposed in the third and fourth slots 372, 388, such that the second slot connector 396 has a first end 408 sized to be disposed in the third slot 372 and a second end 412, opposite the first end 408, sized to be disposed in the fourth slot 388. In this example, the first slot connector 392 has an I-shape in cross-section that is similar to, but slightly more curved than, the shape of the first key 292, whereas the second slot connector 396 has an I-shape that is similar to, but more slightly curved than the second key 296. In other examples, the first and second slot connectors 392, 396 can have a different shape in cross-section (e.g., a rectangular shape, a triangular shape). Moreover, in other examples, e.g., when the manifold 300 only includes two slots, the manifold 300 may include one slot connector. Alternatively, the manifold 300 can include more than two slot connectors (e.g., when it is necessary to couple more than two manifold blocks together).

As discussed above, the first and second slot connectors 392, 396 are retained in position without a manifold plate (e.g. the manifold plate 264). Instead, the first and second slot connectors 392, 396 are retained in position via a plurality of fasteners. More particularly, the first slot connector 392 is retained in position via a first fastener 400A and a second fastener (not shown), while the second slot connector 396 is retained in positon via a third fastener 400C and a fourth fastener (not shown). Each of the plurality of fasteners preferably takes the form of an off the shelf screw, though other fasteners (e.g., retaining rings, spring-operated retainers) can instead be used. In any event, the first fastener 400A is partially, if not entirely, disposed in the first slot 368, such that the first end 400 of the first slot connector 392 is retained in the first slot 368. Similarly, the second fastener is partially, if not entirely, disposed in the second slot 384, such that the second end 404 of the first slot connector 392 is retained in the second slot 384. Likewise, the third fastener 400C is partially, if not entirely, disposed in the third slot 372, such that the first end 408 of the second slot connector 396 is retained in the third slot 372, and the fourth fastener is partially, if not entirely, disposed in the fourth slot 388, such that the second end 412 of the second slot connector 396 is retained in the fourth slot 388. It will be appreciated from FIGS. 3A and 3B that each of plurality of fasteners has a length that is less than 50% (preferably less than 25%, and more preferably less than 10%) of a length of the respective slot in which that fastener is disposed. Further, although the manifold 300 in this example includes four fasteners, it will be appreciated that the manifold 300 may alternatively include less fasteners (e.g., two fasteners) or more fasteners (e.g., more than four fasteners). For example, when the manifold 300 only includes one slot connector, the manifold 300 may only include two fasteners for retaining that slot connector in position.

What is claimed is:

1. A manifold for connecting two or more fluid control devices to a common fluid source, the manifold comprising:
a first manifold block adapted to be coupled to a first fluid control device;
a first slot formed in the first manifold block, the first slot having a substantially circular shape in cross-section;
a second manifold block adapted to be coupled to a second fluid control device;
a second slot formed in the second manifold block, the second slot having a substantially circular shape in cross-section; and
a slot connector configured to couple the first manifold block and the second manifold block together, the slot connector having a first end sized to be disposed in the first slot and a second end sized to be disposed in the second slot.

2. The manifold of claim 1, wherein the first and second slots are drilled into the first and second manifold blocks, respectively.

3. The manifold of claim 1, wherein the first and second ends of the slot connector are retained in the first and second slots, respectively, without a manifold plate.

4. The manifold of claim 1, further comprising:
a first fastener at least partially disposed in the first slot to retain the first end of the slot connector in the first slot; and
a second fastener at least partially disposed in the second slot to retain the second end of the slot connector in the second slot.

5. The manifold of claim 4, wherein the first fastener has a length that is less than 50% of a length of the first slot, and wherein the second fastener has a length that is less than 50% of a length of the second slot.

6. The manifold of claim 1, further comprising a fluid connector having a first end disposed in the first manifold block and a second end disposed in the second manifold block, the fluid connector configured to fluidly connect a first fluid passageway of the first fluid control device to a second fluid passageway of the second fluid control device.

7. The manifold of claim 1, wherein the first slot only extends partially through the first manifold block, and wherein the second slot only extends partially through the second manifold block.

8. A manifold for connecting two or more fluid control devices to a common fluid source, the manifold comprising:
a first manifold block adapted to be coupled to a first fluid control device;
a first slot formed in the first manifold block;
a second manifold block adapted to be coupled to a second fluid control device;
a second slot formed in the second manifold block;
a slot connector configured to couple the first manifold block and the second manifold block together, the slot connector having a first end sized to be disposed in the first slot and a second end sized to be disposed in the second slot;
a first fastener at least partially disposed in the first slot to retain the first end of the slot connector in the first slot; and
a second fastener at least partially disposed in the second slot to retain the second end of the slot connector in the second slot.

9. The manifold of claim 8, wherein the first and second slots are drilled into the first and second manifold blocks, respectively.

10. The manifold of claim 8, wherein the first and second ends of the slot connector are retained in the first and second slots, respectively, without a manifold plate.

11. The manifold of claim 8, wherein the first fastener has a length that is less than 50% of a length of the first slot, and wherein the second fastener has a length that is less than 50% of a length of the second slot.

12. The manifold of claim 8, further comprising a fluid connector having a first end disposed in the first manifold block and a second end disposed in the second manifold block, the fluid connector configured to fluidly connect a first fluid passageway of the first fluid control device to a second fluid passageway of the second fluid control device.

13. The manifold of claim 8, wherein the first slot only extends partially through the first manifold block, and wherein the second slot only extends partially through the second manifold block.

14. A manifold for connecting two or more fluid control devices to a common fluid source, the manifold comprising:
a first manifold block adapted to be coupled to a first fluid control device;
a first slot formed in the first manifold block;
a second manifold block adapted to be coupled to a second fluid control device;
a second slot formed in the second manifold block; and
a slot connector configured to couple the first manifold block and the second manifold block together, the slot connector having a first end sized to be disposed in the first slot and a second end sized to be disposed in the second slot,
wherein the first and second ends of the slot connector are retained in the first and second slots, respectively, without a manifold plate.

15. The manifold of claim 14, wherein the first and second slots are drilled into the first and second manifold blocks, respectively.

16. The manifold of claim 15, wherein each of the first and second slots has a substantially circular shape in cross-section.

17. The manifold of claim 16, further comprising:
a first fastener at least partially disposed in the first slot to retain the first end of the slot connector in the first slot; and
a second fastener at least partially disposed in the second slot to retain the second end of the slot connector in the second slot.

18. The manifold of claim 17, wherein the first fastener has a length that is less than 50% of a length of the first slot, and wherein the second fastener has a length that is less than 50% of a length of the second slot.

19. The manifold of claim 14, further comprising a fluid connector having a first end disposed in the first manifold block and a second end disposed in the second manifold block, the fluid connector configured to fluidly connect a first fluid passageway of the first fluid control device to a second fluid passageway of the second fluid control device.

20. The manifold of claim 14, wherein the first slot only extends partially through the first manifold block, and wherein the second slot only extends partially through the second manifold block
